(19) United States
(12) Patent Application Publication
(10) Pub. No.: US 2005/0257667 A1
(43) Pub. Date: Nov. 24, 2005

(54) Apparatus and computer program for practicing musical instrument

(75) Inventor: Yoshinari Nakamura, Hamamatsu-shi (JP)

Correspondence Address: ROSSI, KIMMS & McDOWELL LLP., P.O. BOX 826, ASHBURN, VA, 20146-0826, US

(73) Assignee: Yamaha Corporation, Hamamatsu-shi (JP)

(21) Appl. No.: 11/135,067

(22) Filed: May 23, 2005

(30) Foreign Application Priority Data
May 21, 2004 (JP) 2004-151411

(51) Int. Cl. A63H 5/00; G04B 13/00; G10H 7/00

(52) U.S. Cl. 84/609

(57) ABSTRACT

An electronic musical instrument stores plural pieces of voice data (i.e., voice waveform data) indicating plural syllables (a, i, u, etc., or do, re, mi, etc.) and automatic performance data indicating a performed music piece. The automatic performance data is composed of a series of note data and information indicating voice data corresponding to the note data. The pitch indicated by the performance information from a keyboard and the pitch indicated by the performance data are compared, and in case where both pitches correspond with each other, the voice data is reproduced with a frequency corresponding to both pitches (steps S21 and S22). In case where both pitches do not correspond with each other, the voice data is reproduced with a frequency having the pitch indicated by the inputted performance information (steps S21, S23 and S24). Therefore, a user can practice playing a musical instrument with fun by getting the user to listen to voices such as lyrics, syllable names (do, re, mi, etc.) or the like.

### BACKGROUND OF THE INVENTION

1. Field of the Invention

The present invention relates to an apparatus and a computer program for practicing a musical instrument.

2. Description of the Related Art

Heretofore, an apparatus for practicing a musical instrument has been known, as disclosed in Japanese Unexamined Patent Application No. HEI6-289857, for example, that compares, every one tone, a pitch indicated by performance information inputted by a user with a pitch indicated by a series of performance data prepared beforehand and indicative of a performed music piece, and when the performance information inputted by the user and the corresponding subject tone of the performance data correspond with each other, causes the user to practice playing a musical instrument every one tone with the tone indicated by the next performance data defined as a to-be-compared tone.

The aforesaid conventional apparatus sounds out the musical instrument sound having a pitch indicated by the inputted performance information or the musical instrument sound having a pitch indicated by the performance data, when the user inputs the performance information. The user practices playing a musical instrument, listening to this musical instrument sound. However, the user may feel that practicing playing the musical instrument is boring, since the user can listen to only the musical instrument sound at all times.

### SUMMARY OF THE INVENTION

The present invention is accomplished in view of the above-mentioned subject, and aims to provide an apparatus and a computer program for practicing playing a musical instrument that makes it possible for a user to practice playing a musical instrument with fun by getting the user to listen to a voice such as the lyrics, syllable names (do, re, mi, etc.) or the like.

In order to attain the above-mentioned object, as shown in FIG. 1 the present invention is characterized by comprising a performance information input portion (BL1) for inputting performance information; a voice data memory (BL2) that stores plural pieces of voice data each indicating each of plural kinds of voices; a performance data memory (BL3) that stores a series of performance data indicating a performed music piece and plural pieces of information each corresponding to each of the series of performance data and each indicating the voice data stored in the voice data memory (BL2); a performance data read-out portion (BL4) that successively reads out the series of performance data stored in the performance data memory (BL3) and reads out information indicating the voice data corresponding to each performance data; a comparing and determining portion (BL5) that makes a comparison and determination as to whether a pitch indicated by the performance information inputted by the performance information input portion (BL1) corresponds with a pitch indicated by the performance data successively read out by the performance data read-out portion (BL4); and a first voice data reproducing portion (BL6) that reproduces voice data stored in the voice data memory (BL2) and corresponding to the information indicating the voice data read out by the performance data read-out portion (BL4), when the comparing and determining portion determines the correspondence in pitches. In this case, the voice generated by the voice data includes, for example, the lyrics, syllable names (do, re, mi or the like), etc. Further, the first voice data reproducing portion (BL6) reproduces the voice data With a frequency having the pitch indicated by the performance data.

In the present invention having the aforesaid configuration, in case where the pitch indicated by the performance information inputted by the user by using the performance information input portion (BL1) corresponds with the pitch indicated by the performance data successively read out from the performance data memory (BL3), the first voice data reproducing portion (BL6) reproduces voice data stored in the voice data memory (BL2) and corresponding to the information indicating the voice data read out by the performance data read-out portion (BL4). Accordingly, the user can practice playing a musical instrument while listening to voices such as the lyrics, syllable names (do, re, mi or the like) etc., not the musical instrument sound, so that the user can practice playing a musical instrument with fun. Further, according to the present invention, when the user plays a musical instrument well, the voices (lyrics, syllable names or the like) are smoothly generated. On the other hand, when the user plays a musical instrument poorly, voices are delayed or broken off. Thus, the user can intuitively grasp the degree of his or her progress in playing a musical instrument.

Another feature of the present invention is that, in addition to the above-mentioned configuration, the invention is provided with a second voice data reproducing portion (BL7) which reproduces the voice data stored in the voice data memory (BL2) and corresponding to the information indicating the voice data read out by the performance data read-out portion (BL4) with a frequency having a pitch different from the performance data successively read out by the performance data read-out portion (BL4), when the comparing and determining portion (BL5) determines that the pitches do not correspond with each other.

In another feature of the present invention, the voice data is reproduced with a frequency having a pitch different from the performance data successively read out by the performance read-out portion (BL4), in case where the user makes a mistake in his or her performance. This allows the user to happen to listen to the voice having a pitch different from the pitch that should be performed, with the result that the user is easy to be aware of the mistake in his or her performance.

Further, the present invention is not limited to an apparatus for practicing playing a musical instrument. The present invention can be embodied as a method for practicing playing a musical instrument and a computer program for practicing playing a musical instrument.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a block diagram showing the present invention;

FIG. 2 is an entire block diagram of an electronic musical instrument according to one embodiment of the present invention;

FIG. 3 is a flowchart showing a performance lesson program executed by the electronic musical instrument;

FIG. 4 is a format diagram of automatic performance data composed of a series of note data and information indicating voice data;

FIG. 5A is a format diagram of a series of note data composing automatic performance data according to a modified example; and

FIG. 5B is a format diagram of a series of information showing a relationship between note data and voice data composing the automatic performance data according to the modified example.

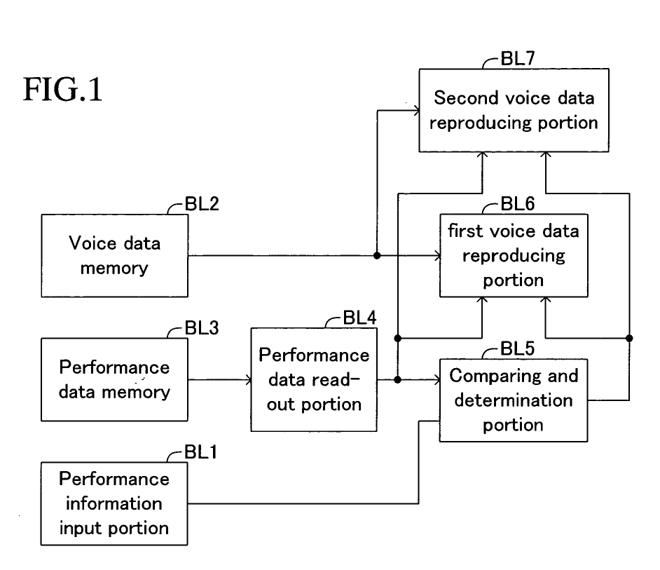

### DESCRIPTION OF THE PREFERRED EMBODIMENT

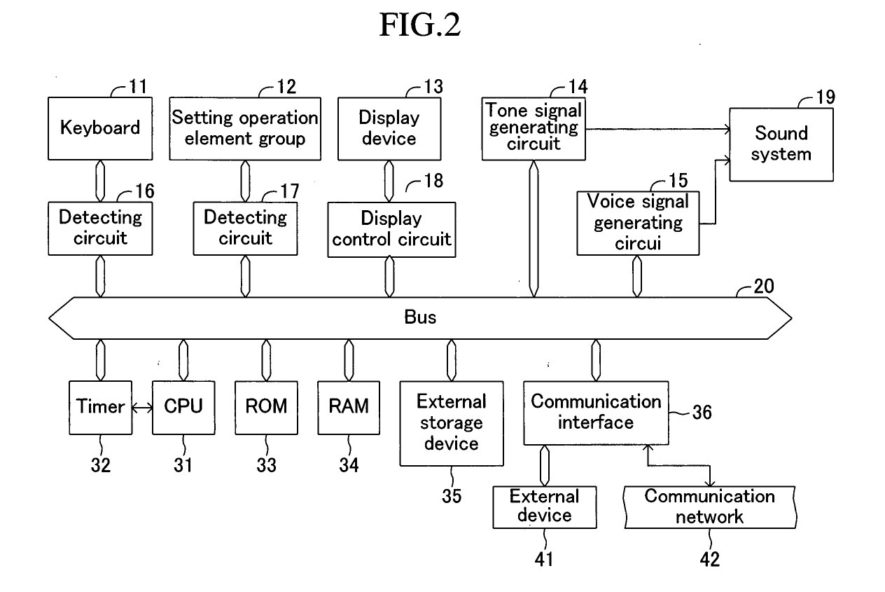

Explained hereinafter is an electronic musical instrument to which an apparatus for practicing playing a musical instrument according to one embodiment of the present invention is applied. FIG. 2 is a block diagram schematically showing this electronic musical instrument. This electronic musical instrument has a keyboard 11, setting operation element group 12, display device 13, tone signal generating circuit 14 and voice signal generating circuit 15.

The keyboard 11 is used to input performance information, and is composed of a plurality of white keys and black keys, each corresponding to pitches over several octaves. The setting operation element group 12 is composed of switch operation elements, volume operation elements, a mouse, cursor moving keys, etc., for setting the operation manner of this electronic musical instrument. The operations of the keyboard 11 and the setting operation element group 12 are respectively detected by detecting circuits 16 and 17 connected to a bus 20. The display device 13 is composed of a liquid crystal display, CRT or the like. It displays characters, numerals, diagrams or the like. The display manner of this display device 13 is controlled by a display control circuit 18 connected to the bus 20.

The tone signal generating circuit 14, which is connected to the bus 20, forms a tone signal based upon later-described note data supplied under the control of a CPU 31, gives an effect to the formed tone signal, and outputs the resultant via a sound system 19. The voice signal generating circuit 15, which is connected to the bus 20, reproduces later-described voice data supplied under the control of the CPU 31 to generate a voice signal and outputs the generated voice signal via the sound system 19. The sound system 19 is composed of an amplifier, speakers or the like.

This electronic musical instrument has the CPU 31, timer 32, ROM 33 and RAM 34, each of which is connected to the bus 20 to compose a main section of a microcomputer. The electronic musical instrument is further provided with an external storage device 35 and a communication interface circuit 36. The external storage device 35 includes a hard disk HD and EEPROM (writable ROM) installed beforehand to this electronic musical instrument, various recording mediums such as a compact disk CD, flexible FD or the like that can be inserted into the electronic musical instrument, and a drive unit corresponding to each recording medium. The external storage device 35 can store and read a large quantity of data and programs.

In this embodiment, the EEPROM stores plural pieces of voice data (i.e., voice waveform data) indicating plural syllables (a, i, u or the like, or do, re, mi or the like) so as to correspond to each of plural pitches. The voice data is utilized to generate a voice indicating the lyrics, syllable names (do, re, mi, etc.) or the like so as to correspond to the timing of a musical note. The voice data is obtained by sampling the voice, generated with a pitch (frequency) of a tone, with a predetermined rate. The reproduction with the above-mentioned rate enables to reproduce a voice having a corresponding pitch (frequency). It should be noted that the voice data (voice waveform data) is stored as divided into waveform data at the voice generation starting section, waveform data at the voice generation ending section and waveform data at the intermediate section between the voice generating starting section and the voice generation ending section, in order to reduce the storage capacity. The length of the generated voice is adjusted by the number of times of repeatedly reading out the waveform data at the intermediate section. A memory device for storing the voice data is not limited to EEPROM. The voice data may be stored beforehand in a hard disk HD, may be supplied to the hard disk HD from a compact disk CD or flexible disk FD, or may be externally supplied to the hard disk HD via a later-described external device 41 or communication network 42.

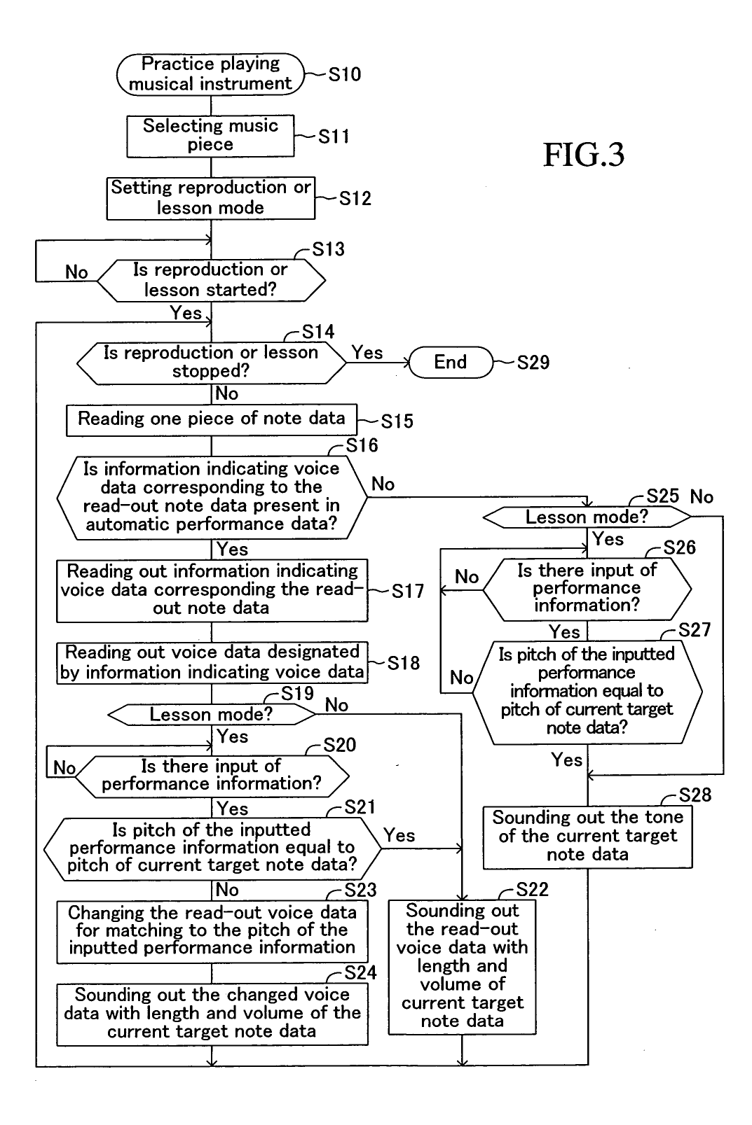

Stored in the hard disk HD are plural pieces of automatic performance data, each corresponding to each of plural music pieces, in addition to various programs including the performance lesson program shown in FIG. 3. The programs and automatic performance data may be stored beforehand in the hard disk HD, may be supplied to the hard disk HD from a compact disk CD or flexible disk FD, or may be externally supplied to the hard disk HD via the later-described external device 41 or communication network 42.

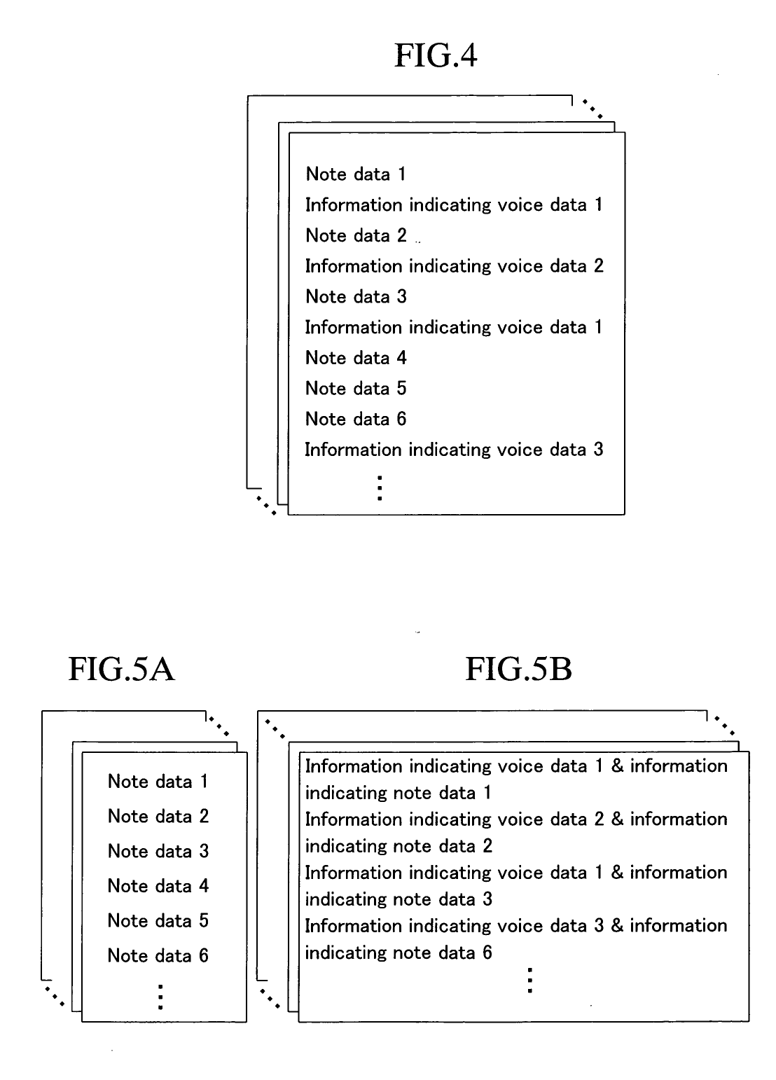

The explanation will be made here about the automatic performance data. FIG. 4 shows plural pieces of automatic performance data corresponding respectively to plural music pieces in the form of format. Each piece of automatic performance data has plural pieces of note data, each indicating a series of musical notes, arranged in accordance with the progression of the music piece (elapse of time). Each piece of note data is constituted by timing data for designating a sound-out timing, pitch data indicating a pitch, musical note length data indicating a length of a musical note and velocity data indicating a sound volume (intensity of key depression). The timing data may be data indicating a relative time interval from the previous musical note or data indicating an absolute time interval from the start of the music piece. Further, added to the automatic performance data is information indicating voice data for generating the lyrics, syllable names (do, re, mi, etc.) so as to correspond to a musical note. The information indicating the voice data means information for specifying one piece of the voice data stored in the aforesaid EEPROM (e.g., identification data ID for specifying a memory to which the voice data is stored, data indicating a syllable and pitch). In the case of FIG. 4, the voice data 1, 2, 1 and 3 correspond respectively to the note data 1, 2, 3 and 6. Further, in FIG. 4, voice corresponding to the note data 4 and 5 is not generated, so that there is no information indicating the voice data corresponding to the note data 4 and 5. Although the automatic performance data is normally composed in accordance with the MIDI standard, it is particularly unnecessary to be in accordance with the MIDI standard.

The communication interface circuit 36 can be connected to the external device 41 such as other electronic musical instruments, personal computer or the like, whereby this electronic musical instrument can communicate various programs and data with the external device 41. A performance apparatus such as, for example, a keyboard may be used as the external device 41, and performance information may be inputted from the external device 41 instead of or in addition to the performance by the keyboard 11. The interface circuit 36 can also be connected to the outside via a communication network 42 such as the Internet, whereby this electronic musical instrument can receive or send various programs and data from or to the outside.

Subsequently, the operation of the embodiment having the aforesaid configuration will be explained. A user operates the setting operation element group 12 to cause the CPU 31 to execute the performance lesson program shown in FIG. 3. The execution of this performance lesson program is started at step S10. The CPU 31 inputs the desired music piece selected by the user's operation on the setting operation element group 12 as a lesson music piece at step S11. Then, the CPU 31 reads out the automatic performance data shown in FIG. 4 and corresponding to the inputted music piece from the external memory device 35 and writes it into the RAM 34. In case where the automatic performance data of the music piece desired by the user is not stored in the external memory device 35, the CPU 31 may read out the desired automatic performance data from the external device 41 that stores the other automatic performance data via the communication interface circuit 36, or may read out the desired automatic performance data from the outside via the communication interface circuit 36 and the communication network 42.

Subsequently, the CPU 31 inputs either one of a reproduction mode and performance lesson mode set by the user's operation on the setting operation element group 12 at step S12. After the process at step S12, the CPU 31 waits for a start instruction by the user's operation on the setting operation element group 12. When the user instructs the start, the CPU 31 makes “YES” determination at step S13, and keeps on executing a circulating process after step S14 until all pieces of performance data of the automatic performance data stored in the RAM 34 are read out, or until the user instructs a stop by the operation on the setting operation element group 12.

At step S15, the CPU 31 reads out the note data from the automatic performance data written in the RAM 34 in accordance with the progression of the music piece (see FIG. 4). In this case, the note data is read out, every process at step S15, one by one from the head of the automatic performance data in accordance with the timing data in the note data. Then, the CPU 31 determines at step S16 whether the information indicating the voice data corresponding to the read-out note data is present in the automatic performance data. If the information indicating the voice data corresponding to the read-out note data is present in the automatic performance data, the CPU 31 makes “YES” determination at step S16, and reads out the information indicating the voice data from the automatic performance data at step S17. Then, at step S18, the CPU 31 reads out one piece of voice data designated by the information indicating the voice data from the voice data group stored in the EEPROM.

Subsequently, when the performance lesson mode is selected as a result of the determination process at step S19, the CPU 31 proceeds to step S20 so as to wait for the input of the performance information. When the performance information is inputted by the performance operation on the keyboard 11 by the user, the CPU 31 makes “YES” determination at step S20, and proceeds to step S21. At step S21, it is determined whether the pitch indicated by the inputted performance information is equal to the pitch of the note data (hereinafter referred to as current target note data) read out by the process at immediately preceding step S15. If both pitches are equal to each other, the CPU 31 reproduces, at step S22, the voice data, that is read out by the process at immediately preceding step S18, with the musical note length and sound volume of the current target note data.

Specifically, the CPU 31 outputs the waveform data at the generation starting section in the read-out voice data to the voice signal generating circuit 15, and then, keeps on repeatedly outputting the waveform data at the intermediate section in the voice data by the time according to the musical note length data of the current target note data, and finally, outputs the waveform data at the generating ending section in the voice data to the voice signal generating circuit 15. Simultaneously, the CPU 31 also outputs the velocity data (sound volume data) of the current target note data to the voice signal generating circuit 15. The voice signal generating circuit 15 makes a digital/analog conversion to the outputted waveform data and controls the sound volume of the converted analog voice signal according to the velocity data, thereby sounding out the analog voice signal having controlled sound volume via the sound system 19.

After the process at step S22, the CPU 31 returns to the process at step S14 so as to repeatedly execute the circulation process after step S14. According to these processes, voices relating to the music piece such as the lyrics or syllable names (do, re, mi or the like) are generated from the sound system 19 in accordance with the progression of the music piece, if the user correctly performs the music piece, that is selected as the lesson music, by using the keyboard 11, i.e., if a key having a correct pitch is depressed at a correct timing. Accordingly, the user can practice playing a musical instrument while listening to voices such as the lyrics, syllable names (do, re, mi or the like) etc., not the musical instrument sound, so that the user can practice playing a musical instrument with fun. On the other hand, when the user depresses a key, having a correct pitch, with some delay with respect to the progression of the music piece, voices are generated with some delay or broken off by the process at step S20. Thus, the user can intuitively grasp the degree of his or her progress in playing a musical instrument.

On the other hand, when the user depresses a key having incorrect pitch, the CPU 31 makes “NO” determination at step S21, i.e., the CPU 31 determines that the pitch indicated by the inputted performance information is not equal to the pitch of the current target note data, and then, proceeds to steps S23 and S24. At step S23, the voice data read by the process at immediately preceding step S18 is changed in order to reproduce the voice data with a frequency of the incorrect pitch. It is possible to change the reading rate of the voice data according to the ratio of the incorrect pitch and the pitch indicated by the pitch data of the current target note data for changing the reproduced frequency of the voice data. However, in this embodiment, the voice data is processed such that a portion of a great deal of sampling data composing the voice data is thinned out or repeated according to the pitch ratio. If the voice data corresponding to the same syllable and corresponding to the pitch indicated by the pitch data of the current target note data is present in the EEPROM, this voice data may be reproduced as it is like the case of step S22.

At step S24, the changed voice data is reproduced with the musical note length and sound volume of the current target note data, like the process at step S22. As a result, the voice data is reproduced, in this case, with the frequency having the pitch indicated by the performance information by the user's incorrect key depression, so that the user happens to listen to the voice having a frequency different from the pitch to be performed. Thus, the user is easy to be aware of the incorrect performance.

In case where the information indicating the voice data corresponding to the note data (i.e., current target note data) read out by the process at step S15 is not present in the automatic performance data, the CPU 31 makes “NO” determination at step S16, and proceeds to step S25. At step S25, it is determined whether the performance lesson mode is selected or not like the determination process at step S19. Since the performance lesson mode is selected in this case, the CPU 31 makes “YES” determination at step S25, and then, proceeds to steps S26 and S27. The processes at steps S26 and S27 are similar to those at steps S20 and S21. The advance of the program is stopped until the performance information is inputted and the pitch indicated by the inputted performance information corresponds with the pitch of the current target note data.

On the other hand, when the user inputs the performance information by using the keyboard 11 and the pitch indicated by the inputted performance information corresponds with the pitch of the current target note data, the CPU 31 outputs the current target note data to the tone signal generating circuit 14 at step S28. The tone signal generating circuit 14 generates the tone signal having the pitch and volume indicated respectively by the pitch data and velocity data composing the note data over the time interval indicated by the musical note length data composing the note data, and outputs the generated tone signal via the sound system 19. The tone color, effect or the like of the tone signal is determined by unillustrated tone color controlling data or effect controlling data embedded in the automatic performance data, or determined by the tone color or effect set by the setting operation element group 12. Accordingly, in case where the information indicating the voice data corresponding to the note data is not present, the musical instrument sound is generated instead of a voice. In this manner, when all pieces of performance data in the automatic performance data stored in the RAM 34 are read out or when the user instructs a stop by the operation on the setting operation element group 12, the CPU 31 makes “YES” determination at step S14 and ends the execution of the performance lesson program at step S29.

In case where the reproduction mode is selected by the process at step S12, the CPU 31 makes “NO” determination at both steps S19 and S25, whereby the processes at steps S22 and S28 are executed. The process at step S22 is for reproducing the voice data, which is read out by the process at immediately preceding step S18, with the musical note length and sound volume of the current target note data. The process at step S28 is for generating a tone according to the note data read out by the process at immediately preceding step S15. Therefore, in this reproduction mode, voice or musical instrument sound relating to the music piece selected as the lesson music is generated according to the progression of the music piece. This makes it possible for the user to listen to a model voice or musical instrument sound.

The electronic musical instrument according to this embodiment is as described above. However, the invention is not limited to the above-mentioned embodiment, and various modifications are possible without departing from the spirit of the invention.

For example, although the information indicating the voice data is inserted into a series of note data in this embodiment, a series of note data and the information indicating series of voice data may be separately stored. A series of note data is prepared in accordance with the progression (elapse of time) of the music piece as shown in FIG. 5A. Further, the information indicating a series of voice data (e.g., identification data ID, data indicating syllable and pitch) is prepared as having attached thereto the information indicating each note data as shown in FIG. 5B. Each note data in FIG. 5A and the voice data stored in the EEPROM can be associated with each other by a pair of the information indicating the voice data and the information indicating the note data. Through this method, existing automatic performance data composed of a series of note data can be utilized without making an edition.

In the above-mentioned embodiment, the read-out process of the voice data by the process at step S18 is carried out immediately after the reading-out process of the information indicating the voice data at step S17. However, instead of this, the process at step S18 may be performed immediately before the process for utilizing the voice data. Specifically, the read-out process at step S18 may be performed immediately before each process at steps S22 and S23.

In the above-mentioned embodiment, when the user depresses a key having an incorrect pitch, the voice data is reproduced with a frequency having the incorrect pitch by the processes at steps S23 and S24. Since this process functions for pointing the mistake in his/her performance, the voice data may be reproduced with a frequency having a pitch different from the pitch indicated by the note data. For example, by the processes at steps S23 and S24, the voice data read out by the process at immediately preceding step S18 may be reproduced with a frequency having a pitch (e.g., one-octave shifted pitch) different from the pitch of the note data read by the process at immediately preceding step S15.

Further, in the above-mentioned embodiment, even in case where the pitch indicated by the inputted performance information is unequal to the pitch indicated by the current target note data, the read-out process of the next note data is continued, i.e., the automatic performance is advanced by the determination process at step S21, under the condition where voice data corresponding to the current target note data is present. However, instead of this, the determination processes at steps S20 and S21 are continued until both of the determination processes at steps S20 and 21 are established, like the processes at steps S26 and S27, whereby the read-out process of the next note data may be inhibited, i.e., the automatic performance may be prevented to be advanced, until both pitches correspond with each other.

Further, in the above-mentioned embodiment, even in case where the pitch indicated by the inputted performance information is unequal to the pitch indicated by the current target note data, the read-out process of the next note data is inhibited, i.e., the automatic performance is prevented to be advanced by the determination processes at steps S26 and S27, under the condition where voice data corresponding to the current target note data is not present. However, instead of this, the progression of the automatic performance is stopped until the determination process at step S26 becomes affirmative, and in case where the determination process at step S26 is affirmative, the process at step S27 and the following steps may be executed. In this case too, when the pitch indicated by the inputted performance information corresponds with the pitch indicated by the current target note data as a result of the determination process at step S27, the CPU 31 may generate the musical instrument sound having the pitch indicated by the current target note data, while the CPU 31 may generate the musical instrument sound having the incorrect pitch by the performer when both pitches do not correspond with each other.

In the determinations at steps S21 and S27, it is only determined whether the pitch indicated by the inputted performance information corresponds with the pitch indicated by the current target note data. However, in addition to the aforesaid determination, timing data in the note data may be referred to, and only when the input timing of the performance information generally corresponds with the timing data, the progression of the automatic performance may be allowed. Moreover, key depression intensity in the key-depression operation on the keyboard 11 may be detected, and the progression of the automatic performance may be allowed when the detected key depression intensity generally corresponds with the key depression intensity (sound volume) indicated by the velocity data in the note data, in addition to the aforesaid condition.

In the above-mentioned embodiment, the automatic performance data is utilized only for the comparison to the performance information inputted by the user. However, in addition to this, a lamp may be arranged on each key of the keyboard 11, and the lamp corresponding to the key to be next depressed may be lighted by using the sequentially read-out note data, whereby the automatic performance data may be used for a performance guide that instructs to the user a key to be depressed. The automatic performance data may further be used for displaying a score on a display device 13, for displaying the keyboard on the display device 13 so as to instruct the key to be next depressed, or for displaying a note name, that should be next depressed, on the display device 13 for instruction.

The above-mentioned embodiment explains about the case where the present invention is applied to an electronic keyboard musical instrument. However, the present invention is not limited to the aforesaid case. The present invention may be applicable to an electronic musical instrument having performance operation elements such as touch plates, push buttons or strings as a performance information input portion. Moreover, the present invention is applicable to a personal computer, so long as a keyboard as the performance information input portion can be connected thereto.

1. An apparatus for practicing playing a musical instrument comprising:
a performance information input portion for inputting performance information;
a voice data memory that stores plural pieces of voice data each indicating each of plural kinds of voices;
a performance data memory that stores a series of performance data indicating a performed music piece and plural pieces of information each corresponding to each of the series of performance data and each indicating the voice data stored in the voice data memory;
a performance data read-out portion that successively reads out the series of performance data stored in the performance data memory and reads out information indicating the voice data corresponding to each performance data;
a comparing and determining portion that makes a comparison and determination as to whether a pitch indicated by the performance information inputted by the performance information input portion corresponds with a pitch indicated by the performance data successively read out by the performance data read-out portion; and
a first voice data reproducing portion that reproduces voice data stored in the voice data memory and corresponding to the information indicating the voice data read out by the performance data read-out portion, when the comparing and determining portion determines the correspondence in pitches.

2. An apparatus for practicing playing a musical according to claim 1, wherein the first voice data reproducing portion reproduces the voice data with a frequency having the pitch indicated by the performance data.

3. An apparatus for practicing playing a musical according to claim 1, wherein the first voice data reproducing portion reproduces the voice data with a length and volume corresponding to a length and volume indicated by the performance data.

4. An apparatus for practicing playing a musical according to claim 1, wherein the voices reproduced by the first voice data reproducing portion are lyrics or syllable names.

5. An apparatus for practicing playing a musical according to claim 1, wherein the performance data memory stores a series of performance data that does not include information indicating the voice data, further comprising:
a tone signal generating portion that generates tone signals based on the series of performance data read out by the performance data read-out portion, when the comparing and determining portion determines the correspondence in pitches.

6. An apparatus for practicing playing a musical according to claim 1, wherein the information indicating the voice data are inserted the series of performance data.

7. An apparatus for practicing playing a musical according to claim 1, wherein the information indicating the voice data and the series of performance data are separately stored.

8. An apparatus for practicing playing a musical according to claim 1, further comprising:
a second voice data reproducing portion which reproduces the voice data stored in the voice data memory and corresponding to the information indicating the voice data read out by the performance data read-out portion with a frequency having a pitch different from the performance data successively read out by the performance data read-out portion, when the comparing and determining portion determines that the pitches do not correspond with each other.

9. An apparatus for practicing playing a musical according to claim 8, wherein the second voice data reproducing portion reproduces the voice data with a frequency having a pitch indicated by the performance information inputted by the performance information input portion.

10. A computer program for practicing playing a musical instrument applied to an apparatus for practicing playing a musical instrument provided with voice data memory that stores plural pieces of voice data each indicating each of plural kinds of voice and performance data memory that stores a series of performance data indicating a performed music piece and plural pieces of information each corresponding to each of the series of performance data and each indicating the voice data stored in the voice data memory;
the computer program including:
a performance information input step for inputting performance information;
a performance data read-out step that successively reads out the series of performance data stored in the performance data memory and reads out information indicating the voice data corresponding to each performance data;
a comparing and determining step that makes a comparison and determination as to whether a pitch indicated by the performance information inputted by the performance information input step corresponds with a pitch indicated by the performance data successively read out by the performance data read-out step; and
a voice data reproducing step that reproduces voice data stored in the voice data memory and corresponding to the information indicating the voice data read out by the performance data read-out step, when the comparing and determining step determines the correspondence in pitches.

11. A computer program according to claim 10, wherein the first voice data reproducing step reproduces the voice data with a frequency having the pitch indicated by the performance data.

12. A computer program according to claim 10, wherein the first voice data reproducing step reproduces the voice data with a length and volume corresponding to a length and volume indicated by the performance data.

13. A computer program according to claim 10, wherein the voices reproduced by the first voice data reproducing step are lyrics or syllable names.

14. A computer program according to claim 10, wherein the performance data memory stores a series of performance data that does not include information indicating the voice data, further including:
a tone signal generating step that generates tone signals based on the series of performance data read out by the performance data read-out step, when the comparing and determining step determines the correspondence in pitches.

15. A computer program according to claim 10, wherein the information indicating the voice data are inserted the series of performance data.

16. A computer program according to claim 10, wherein the information indicating the voice data and the series of performance data are separately stored.

17. A computer program according to claim 10, further including:
a second voice data reproducing step which reproduces the voice data stored in the voice data memory and corresponding to the information indicating the voice data read out by the performance data read-out step with a frequency having a pitch different from the performance data successively read out by the performance data read-out step, when the comparing and determining step determines that the pitches do not correspond with each other.

18. A computer program according to claim 17, wherein the second voice data reproducing step reproduces the voice data with a frequency having a pitch indicated by the performance information inputted by the performance information input step.
